(19) United States
(12) Patent Application Publication
(10) Pub. No.: US 2024/0345877 A1
(43) Pub. Date: Oct. 17, 2024

(54) QUERY PARALLELISM AND MESSAGING INFRASTRUCTURE FOR A CLOUD DATABASE

(71) Applicant: Snowflake Inc., Bozeman, MT (US)

(72) Inventors: Igor Demura, Mountain View, CA (US); Brian Charles Forney, Mountain View, CA (US); Weili Gu, Sunnyvale, CA (US); Mohammad Saber Mirzaei, Seattle, WA (US); William Waddington, Stateline, NV (US); Jiaqi Yan, Menlo Park, CA (US)

(21) Appl. No.: 18/300,738

(22) Filed: Apr. 14, 2023

(51) Int. Cl. G06F 9/48; G06F 9/54

(52) U.S. Cl. CPC G06F 9/4881; G06F 9/547

(57) ABSTRACT

Techniques for creating child jobs in network-based data systems are described. A request to create a child job for a parent job can be received at a first compute service manager. A child job token can be generated, and a request message can be generated including the child job token and configuration information. The request message can be transmitted to a second compute service manager, where the child job can be constructed linking the child job to the parent job based on the child job token and configuration information. A response message can be received from the second compute service manager including confirmation that the child job was created.

### TECHNICAL FIELD

The present disclosure generally relates to data systems, such as data warehouses, and, more specifically, to creating child jobs and messaging infrastructure for communication with the child jobs in a cloud database.

### BACKGROUND

As the world becomes more data driven, database systems and other data systems are storing more and more data. Data systems, such as database systems, may be provided through a cloud platform, which allows organizations and users to store, manage, and retrieve data from the cloud. For a business to use this data, different operations or queries are typically run on this large amount of data. Executing queries over large amounts of data can involve long processing times.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 shows an example of a query tree, according to some example embodiments.

FIG. 5 is a simplified block diagram of a job creation system, according to some example embodiments.

FIG. 6 shows an example of a set of construction lists to create a job, a query coordinator, and a statement, according to some example embodiments.

FIG. 7 shows a flow diagram for a method for creating a remote child job, according to some example embodiments.

FIG. 8 shows a simplified block diagram of a messaging system 800, according to some example embodiments.

FIG. 9 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for creating child jobs at the same or different location (remote) than the parent job. A designated API (Application Programming Interface) can be used to create the child jobs. The API can use a builder pattern to describe the new job, which is translated to configuration information, such as a construction list. The construction list can be used to create the child job either locally or remotely. Also, a messaging system between the parent job and child jobs is described, which can be used to transmit messages between the parent job and the child jobs either one-way or bi-directional.

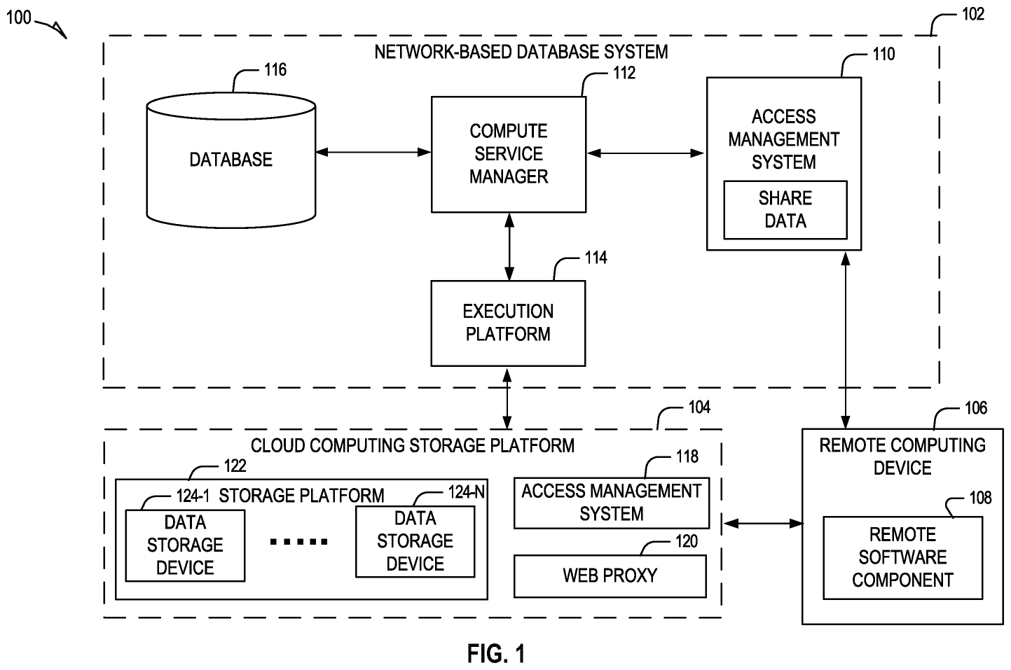

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

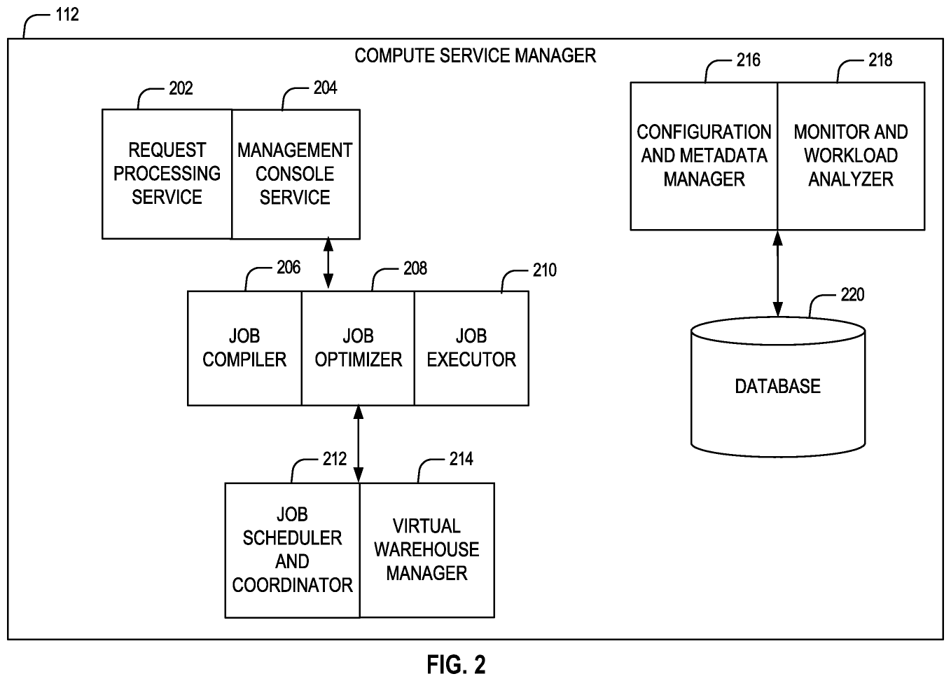

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represents any data storage device within the network-based database system 102. For example, data storage device 220 may represent caches in execution platform 114, storage devices in cloud computing storage platform 104, or any other storage device.

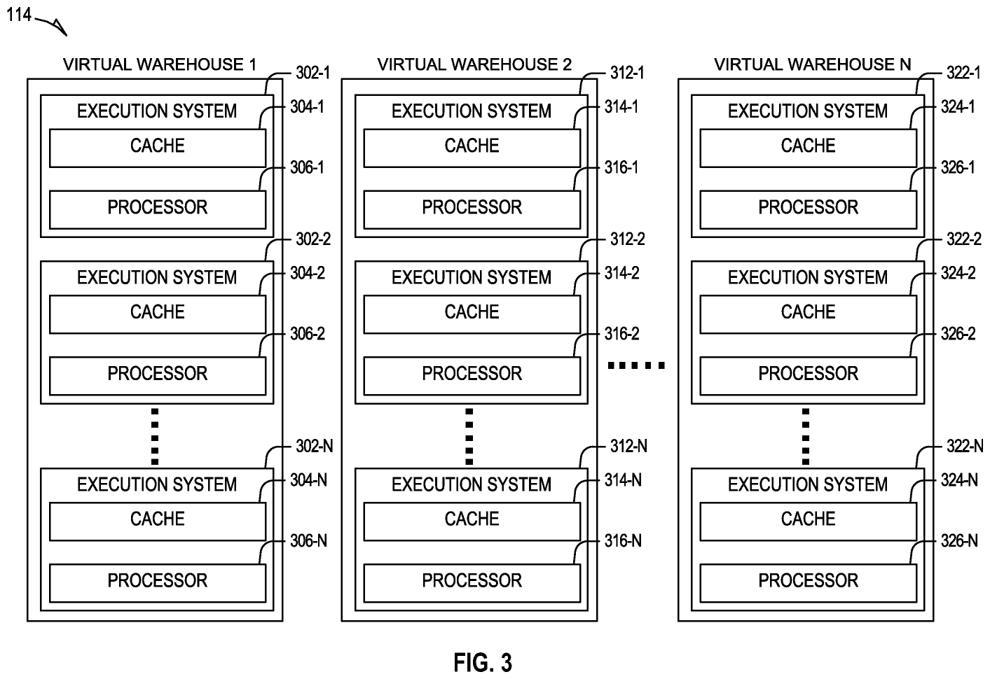

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Query execution on large amounts of data can consume significant time and resources. Techniques for increasing the speed of query executions and using computing resources more efficiently are described below. In some systems, execution of a query is commonly represented by a single job handled by a compute service manager (also referred to as a global service (GS)) at a point in time. In a GS, this makes executing a work of a query largely single threaded and contained to a single GS instance. A growing number of use cases require or benefit from decomposing the work of a single query across multiple jobs and possibly distributing them across a GS cluster. These queries can be referred to as decomposed queries since they can be decomposed into smaller parts that can be executed in parallel. A decomposed query can be executed by more than one job without the use of additional SQL queries. Examples of features that can produce decomposed queries are Query Acceleration Service, Memoized Functions, and Schema Evolution, as described below.

For example, query execution can be accelerated by scaling out parallel parts of a query (also referred to as a fragment) to additional computing resources. A fragment refers to parts of a query plan that may be performed using additional computing resources in parallel (and in isolation), i.e., a parallelizable part of a query plan. A set of criteria may be used to identify a portion or portions of the query plan that may be eligible for fragment processing. In some embodiments, a piece of a plan, which may include an operator or set of operators, with only local links may be eligible for fragment processing. Additionally, that operator or set of operators may begin with a table scan operation to be eligible for fragment processing. Because only local links connect the identified operations, the computing resource may execute those identified operations without communicating with other resources, thereby making it eligible for fragment processing. For example, those operations may include operations that can be executed locally by a computing resource on data in a database, data set, a micro partition, or the like. Examples of such operators may include, but are not limited to, table scan, filter, child aggregation, projection, bloom filter, and so forth.

In some examples, the different parts or fragments can be considered child jobs for the parent query/job. Executions of the parts of the query may be coordinated by a parent query coordinator (where the query originated) and other fragment query coordinators. Files for the query may be loaded in a shared file queue as a continuous scanset, from which the parent query coordinator and fragment coordinator(s) can request batches of files serially (e.g., one at a time) as they complete processing their currently assigned batch. The fragment computing resources may generate materialized results and load them into another shared file queue. The materialized results may be consumed by the parent query coordinator subsequent to all files in the continuous scanset being processed. This query execution model therefore provides increased speed as well as flexibility, especially when the number of resources can dynamically change during the query execution. Typically, the different fragments are considered child jobs to the parent query, and the child jobs are typically handled by the same compute service manager (also referred to as a global service (GS)), which can limit the efficient use of computing resources.

Another use case scenario of child jobs is memoized functions. Memoizable functions enhance processing by caching results opportunistically. Internally, a data platform will skip executing the function again and fetch the result directly if it is still applicable. For security policies such as row access policies, customers can leverage memoizable functions to rewrite their policy body. Using memoizable functions can avoid expensive JOINs between look-up tables and policy protected tables and improve performance. With memoizable functions, users can dissect interesting parts of a complex query and use them across different queries. The system can execute the memoizable function in a separate child job, caches the function result, and apply the result back into the query which uses the memoizable function. Accordingly, memoizable functions provide a mechanism that allows users to supply custom logic/queries to load information, cache the loaded results and use them in other queries where only simple look up is needed by doing partition pruning instead of joins.

In some examples, the system can apply an interleaved execution workflow for a memoizable function execution meaning that the system launches a separate child job created specifically to execute the memoizable function. When executing a memoizable function in a query, the system creates a separate child job to execute the memoizable function, caches the result of the executed memoizable function, and plugs the result back into the original job. Typically, the memoizable functions are considered child jobs to the parent query, and the child jobs are typically handled by the same compute service manager (GS), which can limit the efficient use of computing resources.

Schema evolution can also employ child jobs. When data is being uploaded into a source table, the schema of the data to be uploaded can be compared with the schema for the source table. If a schema mismatch is detected, the schema of the source table can be modified, and the upload can be continued without data loss. The schema for the source table may be modified based on an error message detecting the mismatch. For example, the compute service manager may construct a Data Definition Language (DDL) statement to modify the schema for the source table based on the information in the error message. For adding a new column, a DDL statement of “ALTER TABLE ADD COLUMN” may be executed. In some examples, an internal code equivalent to the DDL statement may be run; in this case, the DDL statement may not appear in the query history. For changing the nullability of a column, another corresponding alter command may be executed. In some examples, an internal command equivalent may be run so that the overall schema evolution can be executed as a single command. The command may change a column from non-nullable to nullable. Child jobs may be used to perform schema evolution, but the child jobs are typically handled by the same compute service manager (GS).

Additionally, there are a set of use cases that lead to a tree of queries. These queries are the result of one query requiring the execution of another query to complete. This can happen recursively. A stored procedure feature is an example use case. A query can start a stored procedure which can contain a query inside of it. That query could be another stored procedure. Each of these stored procedures is executed as a separate Job. This type of use case generates chained queries, which is a query that creates more queries, possibly recursively.

For decomposed queries and chained queries, multiple jobs can be used to track and assist in executing the queries. The jobs can be mapped on to a tree structure where the root is called a parent-most job, which is a job that has no parent job. The parent-most job is the job created in response to an external query or a task running a scheduled query. The parent-most job's query is also referred to as a keystone query. The tree can grow over the course of executing the keystone query. Each subsequent job created to execute the keystone query is called a child job. In the case of chained queries, some of the child jobs in the job tree are executing the queries created by executing the keystone query.

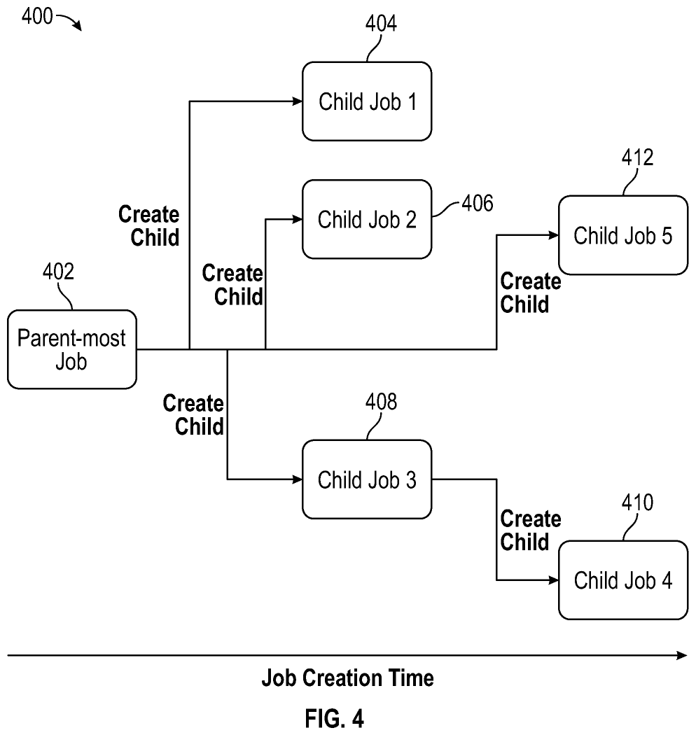

FIG. 4 shows an example of a query tree 400, according to some example embodiments. The query tree 400 can include a combination of decomposed queries and chained queries or just one type of query. A parent-most job 402 is the keystone query in this example. The parent-most job 402 may create a plurality of child jobs. For example, the parent-most job 402 may spawn child job 1 404, child job 2 406, child job 3 408, and child job 5 410 over the course of executing the keystone query. In this example, child job 3 408 may create a child job 4 410 of its own. Therefore, from the perspective of child job 4 410, child job 3 408 is the parent job for child job 4 410.

As mentioned above, in some systems, child jobs are relegated to the same GS instance as its parent job. However, a job creation infrastructure described herein allows creating jobs in remote GS instances. The job creation infrastructure also provides messaging capabilities between parent and child jobs.

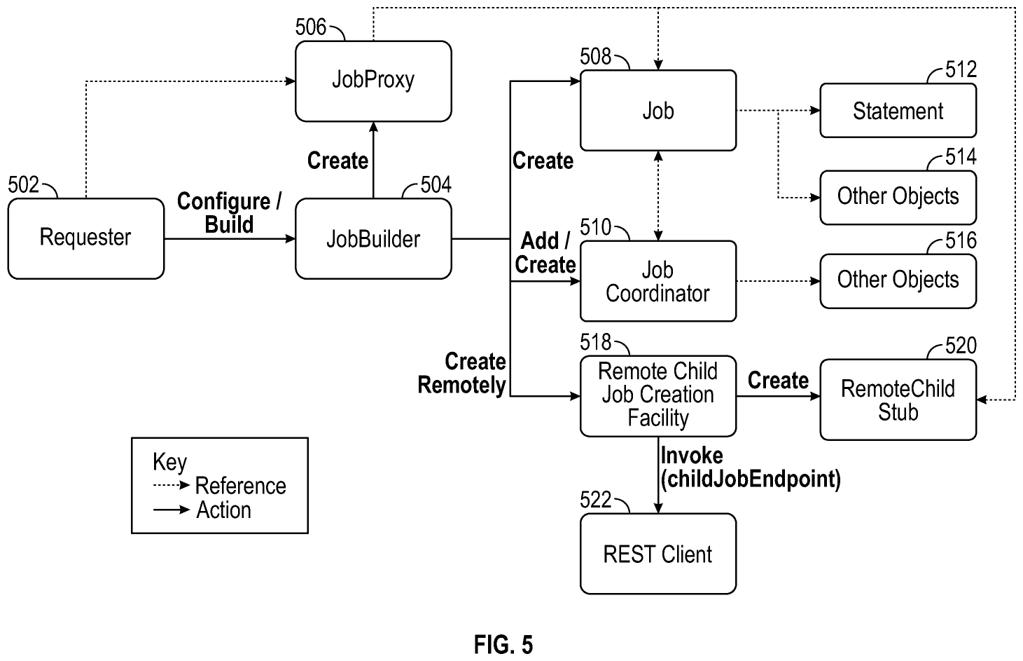

FIG. 5 is a simplified block diagram of a job creation system 500, according to some example embodiments. The job creation system 500 includes a requestor 502, which is an object that requests to create and start a child job. The requestor 502 can be a piece of code that wants to create a child job, such as a parent job. The requestor 502 transmits a request for creating and running a child job to a job builder 504. The job builder 504 can include method calls configured for creating child jobs. In response to receiving the request from the requestor 502, the job builder 504 may create a job proxy 506 for the requested child job. The job proxy 506 can represent a façade of the child job, which as explained in further detail below, can be used for communication between the parent and child jobs.

Also, in response to receiving the request from the requestor 502, the job builder 504 checks an affinity setting. The affinity setting may be included in the request. The affinity setting may indicate whether the requested child job should be created in the same GS instance as the requestor 502 (e.g., parent job/query) or can be created in remote GS instances. For example, the affinity setting may be “local-only” or “any.” For “local-only,” the child job is designated for the same GS as the requestor 502. For “any,” the child job can be created on any GS instance in the same GS cluster (including the same GS instance as the requestor 502), which would include remote GS instances.

When the affinity setting is set to “local-only,” the job builder 504 validates the configuration of the requested job and creates a job 508, which is the requested child job. The job builder 504 also creates or adds a job coordinator 510 for the job 508. The job 508 may be associated with a statement 512 and other objects 514 that are needed for executing the job 508. The statement 512 may be a SQL statement associated with the job 508. The job coordinator 510 (also referred to as a query coordinator) is an object that coordinates execution of the job as described herein (e.g., a thread in the system). The job 508 and job coordinator 510 reside in the same GS instance as the requestor 502 because the affinity setting was set to “local-only.”

When the affinity setting is set to “any” and a remote GS instance is chosen (e.g., determined by round robin selection), the job builder 504 invokes a remote child job creation facility 518 for creating a remote job 520 (represented by a remote child stub) with a token and configuration information for creating the remote job 520. The remote job 520 may be created in a different GS instance than the requestor 502. The remote job 520 may include a job coordinator and associated objects, such as a statement, at the remote GS instance. The remote child job creation facility 518 can invoke a child job endpoint with Representational state transfer (REST) client 522. The REST request may include configuration information for the remote GS instance to create the remote job 520 and its job coordinator and other associated objects.

After the requested child job is created (whether locally with job 508 or remotely with remote job 520), the job builder may return the job proxy 506 to the requestor 502. As described in further detail below, the job proxy 506 may be used for interfacing between the parent job and the child job and, for example, may be used to abort the child job, send to and receive messages from the child job, retrieve information about the child job (e.g., job ID), etc.

The configuration information to create the child job may include a construction list (also referred to as a recipe). The use of a construction list allows the use of relatively simple interfaces between the job builder 504 and the remote child job creation facility 518, and also allows for validation that the operations in the construction list will produce a valid job object along with any other objects that may be created. The construction list may include an operation type. The operation type can include a call constructor, which invokes a constructor on a class. The operation type can also include a set, which sets a field on an object generated by a call constructor log entry. The operation type may also include a build and set information, which specifies a job builder. The build and set information can be used to create an object other than a job object, such as a job coordinator or statement object.

The construction list can include an operation name, which defines the name of a setter or builder, and arguments information. Arguments information can include a list of arguments to be provided to a constructor or setter.

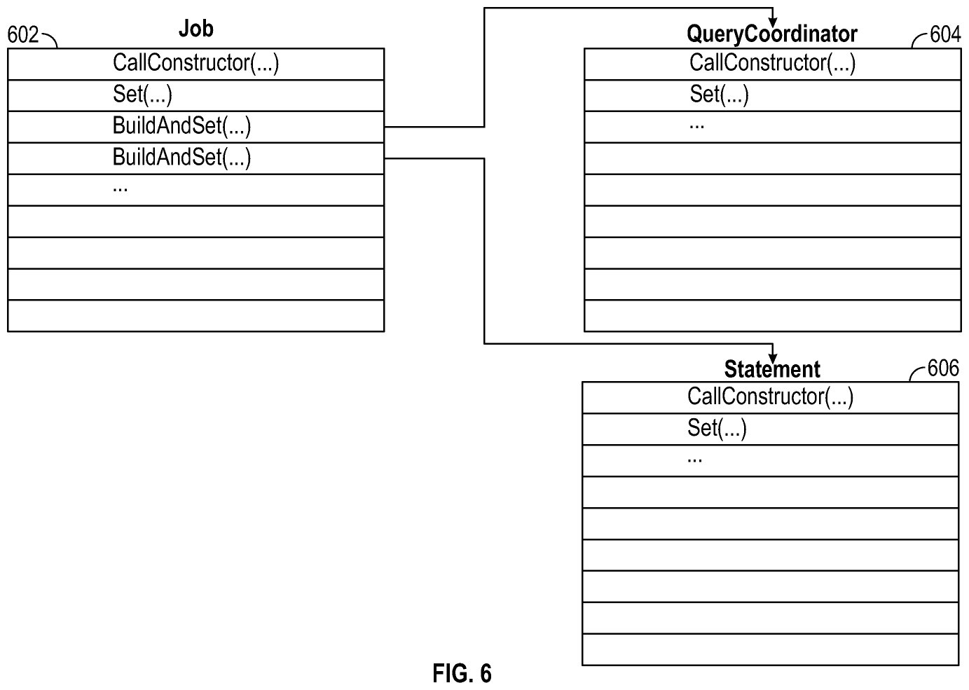

FIG. 6 shows an example of a set of construction lists to create a job, a query coordinator, and a statement. A job construction list 602 includes call construction, set, and build and set information to create a job. The job construction list 602 can be used to define a job coordinator construction list 604, which includes call construct and set information, to create a corresponding job coordinator for the created job. The job construction list 602 can also be used to define a statement construction list 606, which includes call construct and set information, to create a corresponding statement for the created job.

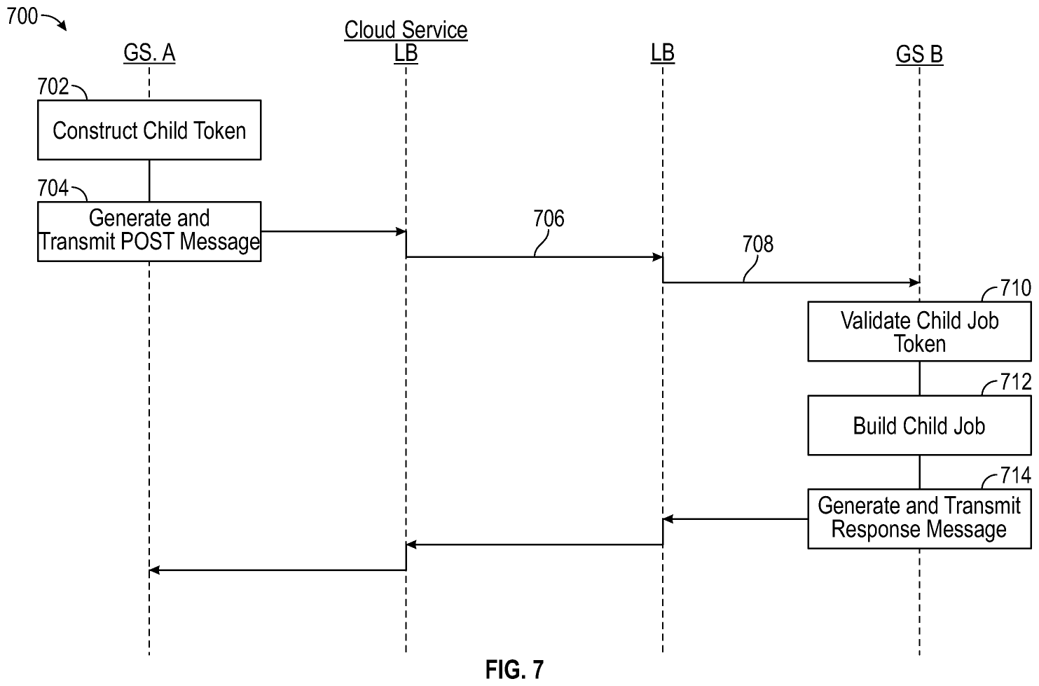

FIG. 7 shows a flow diagram for a method 700 for creating a remote child job, according to some example embodiments. GS A is the GS instance where the parent job/query resides. The parent job/query requests that a child job be created for handling some operation related to the parent job. The job builder for the parent job may check the affinity setting and determine that the child job can be created in a remote GS (i.e., not limited to GS A). At operation 702, The job builder may construct a child job token, which may be acquired by making a Java method call. The child job token may include a unique ID, a parent job ID, token creation time, and time-to-live (TTL) value to express the token's lifespan, and a digital signature. The child job token can be based on a security token class.

At operation 704, the job builder in GS A may generate and transmit a POST message to a cloud service provider load balancer (LB). The POST message may include a REST request header and REST body. The REST request header may include an authorization header field with the child job token and child job token string. The REST body may include a list containing nested construction lists, as described above. The POST message is transmitted using an account URL. At operation 706, the POST message is routed by the cloud service provider LB to the data system's LB. At operation 708, the data system's LB makes a load-balancing decision using a configured policy (e.g., round-robin, weighted, etc.) to select GS B as the destination instance for the child job request.

At operation 710, GS B receives the POST message and validates the child job token using a secure request dispatcher verifying the token information, such as the signature, liveliness, existence of a parent job with the specified parent job ID, the parent job's persisted state is non-terminal, and the parent job's session is not closed. An unsuccessful token verification can lead to a failure response with an error message.

At operation 712, if the child job token is verified, GS B reads the REST body and builds the child job based on the configuration information included therein. The building of the child job may be processed using an internal query method of the data system (as opposed to an external query from a user) to expedite creation of the child job. For example, GS B processes the construction list and parameters and can submit the child job for async execution.

At operation 714, GS B will generate and transmit back a response message to GS A to confirm that the child job has been created and is running. The response may include a child job ID, GS ID, and confirmation that the child job creation was successful (or error code if the creation was not successful).

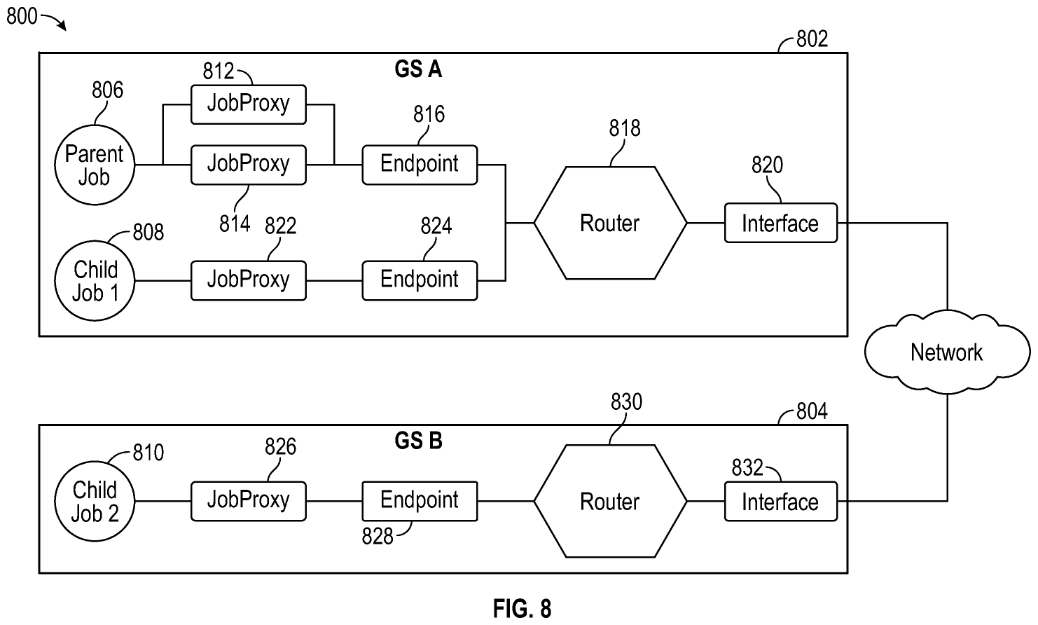

Messaging between the parent and child job can now be initiated. For example, contents of the response message may be used to set up routing between the parent and child job. FIG. 8 shows a simplified block diagram of a messaging system 800, according to some example embodiments. The messaging system 800 includes objects in GS A 802 and GS B 804. Other GS instances can be included. GS A 802 includes a parent job 806, which creates two child jobs. Child job 1 808 may be created in GS A 802, while child job 2 810 may be created in GS B 804.

The parent job 806 is coupled to a job proxy 812 corresponding to child job 1 808, and the parent job 806 is coupled to a job proxy 814 corresponding to child job 2 810. The job proxy 812 and job proxy 814 are coupled to an endpoint 816, which is in turn coupled to a router 818. The router 818 is coupled to an interface 820 (e.g., GS-GS interface).

Child job 1 808 is coupled to a job proxy 822 corresponding to parent job 806. The job proxy 822 is coupled to an endpoint 824, which is coupled to router 818. Child job 2 is coupled to a job proxy 826 corresponding to parent job 806. The job proxy 826 is coupled to an endpoint 828, which is in turn coupled to router 830, which is in turn coupled to an interface 832.

The job proxy 812 may act like a façade of parent job 806 for child job 1 808. The job proxy 814 may act like a façade of parent job 806 for child job 2 810. Endpoint 816 may add a source job UUID to outgoing messages. For incoming messages, the endpoint 816 may direct a message to either job proxy 812 or job proxy 814 depending on the source job (i.e., messages from child job 1 808 are routed to job proxy 812 and messages from child job 2 810).

The router 818 directs messages between endpoints when the destination is a different GS instance and thus between the interface respective components (820, 832) for remote messaging. For example, router 818 directs messages between parent job 806 and child job 1 808 1 directly using endpoint 816 and endpoint 824. The interface 820 is a component that utilizes a stateless dedicated service (DS) framework to access gRPC (Remote Procedure Call) to send and receive messages between GS A 802 and GS B 804. The interface 820 may send messages to the messaging layer of job proxies by wrapping the respective message in an envelope message that contains additional information about the source and destination GS instances and the source and destination jobs.

The messaging system 800 allows communication between parent and child jobs. For example, child job 2 810 can transmit messages to parent job 806. In this situation, child job 2 810 may generate a message and forward it to job proxy 826. The job proxy 826 may attach an ID for the parent job 806 and forward the message endpoint 828. The endpoint 828 may mark the destination endpoint 816 based on the ID of the parent job 806 and forward the message to router 830. The router 830 may determine an IP address of router 818 or endpoint 816 and may forward the message to interface 832. The interface 832 may wrap the message in an envelope message as described above and may transmit the message to interface 820 of GS A 802. The message may then be routed downstream through the router 818, which routes it to the correct endpoint 816, corresponding to parent job 806. The endpoint 816 may then route it to the correct job proxy 814, which corresponds to child job 2. The job proxy 814 then routes the message to parent job 806.

The messaging system 800 can support different styles of communication. For example, post-style communication can be supported where a message is transmitted, and no reply is expected. Send-style communication can also be supported where a message is transmitted, and a reply message is expected. The messages transmitted between parent and child jobs may be small control messages, such as messages to abort child jobs in a cascade fashion. In some examples, small amount of results can be transmitted from child job to parent job. A parent job can also send small amount of data to configure the child job for further execution.

The parent-child job interfacing techniques described herein can facilitate job retry of stored procedures, such as UDF (User Defined Function) that can support child jobs. A stored procedure jobs use compilation of an effective execution context to contain correct rights (Caller's Rights or Owner's Rights). Owner's rights represent the rights of the owner of the stored procedure. Caller's rights represent the rights of the user calling the stored procedure. The techniques facilitate the ability to transmit rights information in a job retry message that is consumed by a new GS instance that creates and executes the retry job and to generate rights information when a request is processed. For example, if a child job associated with a stored procedure fails, a retry message may be created and the effective execution context of the child job may be stored in a metadata database. When a new GS instance receives the retry message, the new GS instance may load the context for the failed child job from the metadata database. The new GS instance can then execute the child job appropriately. Hence, the child job can be retried without instruction from the parent job (i.e., transparent to parent job).

The parent-child job interfacing techniques described herein can facilitate cascade job aborts. For example, a customer submits a query, which becomes the parent job. The parent job spawns multiple child jobs using the child job creation techniques described herein. The query may be cancelled. The cancellation of the query may trigger a cascaded abort of the child jobs. For example, the parent job may transmit abort messages to the child jobs in response to the parent job being aborted.

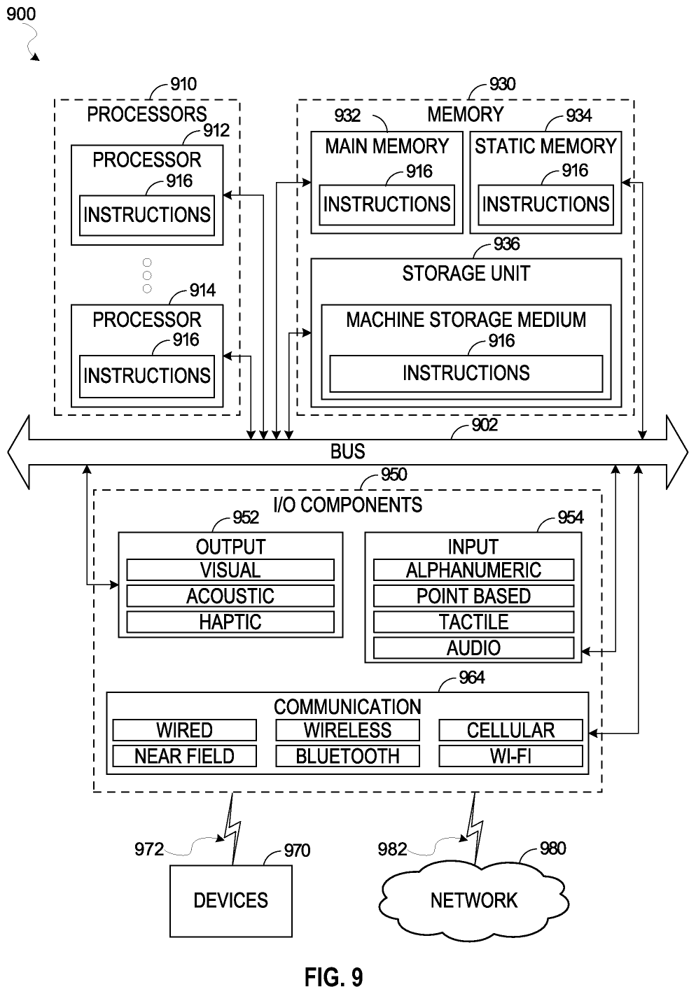

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute any one or more operations of any one or more of the methods described herein. As another example, the instructions 916 may cause the machine 900 to implement portions of the data flows described herein. In this way, the instructions 916 transform a general, non-programmed machine into a particular machine 900 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 includes processors 910, memory 930, and input/output (I/O) components 950 configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core processor), multiple processors with a single core, multiple processors with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 include components to receive input, provide output, produce output, transmit information, exchange information, capture measurements, and so on. The specific I/O components 950 that are included in a particular machine 900 will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, and other communication components to provide communication via other modalities. The devices 970 may be another machine or any of a wide variety of peripheral devices (e.g., a peripheral device coupled via a universal serial bus (USB)). For example, as noted above, the machine 900 may correspond to any one of the remote computing device 106, the access management system 118, the compute service manager 112, the execution platform 114, the access management system 110, the Web proxy 120, and the devices 970 may include any other of these systems and devices.

The various memories (e.g., 930, 932, 934, and/or memory of the processor(s) 910 and/or the storage unit 936) may store one or more sets of instructions 916 and data structures (e.g., software) embodying or utilized by any one or more of the methodologies or functions described herein. These instructions 916, when executed by the processor(s) 910, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving, at a first compute service manager, a request to create a child job for a parent job; generating a child job token; generating a request message including the child job token and configuration information; transmitting the request message to a second compute service manager; the second compute service manager configured to construct the child job linking the child job to the parent job based on the child job token and configuration information; and receiving, at the first compute service manager, a response message from the second compute service manager including confirmation that the child job was created.

Example 2. The method of example 1, wherein the configuration information includes a construction list defining an operation type for the child job.

Example 3. The method of any of examples 1-2, further comprising: creating, at the first compute service manager, a first job proxy representing the child job for the parent job, wherein a second job proxy is created at the second compute service manager representing the parent job for the child job.

Example 4. The method of any of examples 1-3, wherein the first job proxy and the second job proxy are used for direct communication between the parent job and the child job.

Example 5. The method of any of examples 1-4, further comprising: generating a communication message to transmit from the parent job to the child job; wrapping the communication message in an envelope message containing information about source compute service manager, destination compute service manager, source job, and destination job; and transmitting the wrapped communication message using a remote procedure call.

Example 6. The method of any of examples 1-5, wherein the child job token includes a unique ID, a parent job ID, a token creation time, and a time-to-live value.

Example 7. The method of any of examples 1-6, wherein the response message includes a child job ID and a compute service manager ID.

Example 8. The method of any of examples 1-7, further comprising: transmitting an abort message to the child job in response to the parent job being aborted.

Example 9. A system comprising: one or more processors of a machine; and a memory storing instructions that, when executed by the one or more processors, cause the machine to perform operations implementing any one of example methods 1 to 8.

Example 10. A machine-readable storage device embodying instructions that, when executed by a machine, cause the machine to perform operations implementing any one of example methods 1 to 8.

What is claimed is:

1. A method comprising:
receiving, at a first compute service manager, a request to create a child job for a parent job;
generating a child job token;
generating a request message including the child job token and configuration information;
transmitting the request message to a second compute service manager; the second compute service manager configured to construct the child job linking the child job to the parent job based on the child job token and configuration information; and
receiving, at the first compute service manager, a response message from the second compute service manager including confirmation that the child job was created.

2. The method of claim 1, wherein the configuration information includes a construction list defining an operation type for the child job.

3. The method of claim 1, further comprising:
creating, at the first compute service manager, a first job proxy representing the child job for the parent job, wherein a second job proxy is created at the second compute service manager representing the parent job for the child job.

4. The method of claim 3, wherein the first job proxy and the second job proxy are used for direct communication between the parent job and the child job.

5. The method of claim 4, further comprising:
generating a communication message to transmit from the parent job to the child job;
wrapping the communication message in an envelope message containing information about source compute service manager, destination compute service manager, source job, and destination job; and
transmitting the wrapped communication message using a remote procedure call.

6. The method of claim 1, wherein the child job token includes a unique ID, a parent job ID, a token creation time, and a time-to-live value.

7. The method of claim 1, wherein the response message includes a child job ID and a compute service manager ID.

8. The method of claim 1, further comprising:
transmitting an abort message to the child job in response to the parent job being aborted.

9. A machine-storage medium embodying instructions that, when executed by a machine, cause the machine to perform operations comprising:
receiving, at a first compute service manager, a request to create a child job for a parent job;
generating a child job token;
generating a request message including the child job token and configuration information;
transmitting the request message to a second compute service manager; the second compute service manager configured to construct the child job linking the child job to the parent job based on the child job token and configuration information; and
receiving, at the first compute service manager, a response message from the second compute service manager including confirmation that the child job was created.

10. The machine-storage medium of claim 9, wherein the configuration information includes a construction list defining an operation type for the child job.

11. The machine-storage medium of claim 9, further comprising:
creating, at the first compute service manager, a first job proxy representing the child job for the parent job, wherein a second job proxy is created at the second compute service manager representing the parent job for the child job.

12. The machine-storage medium of claim 11, wherein the first job proxy and the second job proxy are used for direct communication between the parent job and the child job.

13. The machine-storage medium of claim 12, further comprising:
generating a communication message to transmit from the parent job to the child job;
wrapping the communication message in an envelope message containing information about source compute service manager, destination compute service manager, source job, and destination job; and
transmitting the wrapped communication message using a remote procedure call.

14. The machine-storage medium of claim 9, wherein the child job token includes a unique ID, a parent job ID, a token creation time, and a time-to-live value.

15. The machine-storage medium of claim 9, wherein the response message includes a child job ID and a compute service manager ID.

16. The machine-storage medium of claim 9, further comprising:
transmitting an abort message to the child job in response to the parent job being aborted.

17. A system comprising:
at least one hardware processor; and
at least one memory storing instructions that, when executed by the at least one hardware processor, cause the at least one hardware processor to perform operations comprising:
receiving, at a first compute service manager, a request to create a child job for a parent job;
generating a child job token;
generating a request message including the child job token and configuration information;
transmitting the request message to a second compute service manager; the second compute service manager configured to construct the child job linking the child job to the parent job based on the child job token and configuration information; and
receiving, at the first compute service manager, a response message from the second compute service manager including confirmation that the child job was created.

18. The system of claim 17, wherein the configuration information includes a construction list defining an operation type for the child job.

19. The system of claim 17, the operations further comprising:
creating, at the first compute service manager, a first job proxy representing the child job for the parent job, wherein a second job proxy is created at the second compute service manager representing the parent job for the child job.

20. The system of claim 19, wherein the first job proxy and the second job proxy are used for direct communication between the parent job and the child job.

21. The system of claim 20, the operations further comprising:
generating a communication message to transmit from the parent job to the child job;
wrapping the communication message in an envelope message containing information about source compute service manager, destination compute service manager, source job, and destination job; and
transmitting the wrapped communication message using a remote procedure call.

22. The system of claim 17, wherein the child job token includes a unique ID, a parent job ID, a token creation time, and a time-to-live value.

23. The system of claim 17, wherein the response message includes a child job ID and a compute service manager ID.

24. The system of claim 17, the operations further comprising:
transmitting an abort message to the child job in response to the parent job being aborted.
